(19) United States
(12) Patent Application Publication
(10) Pub. No.: US 2016/0219657 A1
(43) Pub. Date: Jul. 28, 2016

(54) GASKET FOR A HEAT-CHARGED CAVITY OF AN APPLIANCE WITH MICROWAVE HEATING FUNCTION

(71) Applicant: ELECTROLUX APPLIANCES AKTIEBOLAG, Stockholm (SE)

(72) Inventors: Arnd Hofmann, Rothenburg ob der Tauber (DE); Klaus Schlötter-Er-Fratoianni, Rothenburg ob der Tauber (DE)

(21) Appl. No.: 14/915,391

(22) PCT Filed: Oct. 13, 2014
(86) PCT No.: PCT/EP2014/071869

§ 371 Date: Feb. 29, 2016

(30) Foreign Application Priority Data
Oct. 23, 2013 (EP) PCT/EP2013/072149
Jan. 27, 2014 (EP) PCT/EP2014/051487
Jul. 30, 2014 (EP) 14179025.3

(51) Int. Cl. H05B 6/76; F16J 15/10; F16J 15/06; F16J 15/12; F24C 15/02; F16J 15/02

(52) U.S. Cl. CPC H05B 6/763; H05B 6/76; F24C 15/021; F16J 15/021; F16J 15/064; F16J 15/12; F16J 15/102

(57) ABSTRACT

The present invention relates to a gasket (10) for a heat-charged cavity of an appliance with microwave heating function. The gasket (12) comprises a first gasket part (12), a second gasket part (14) and an interconnecting gasket part (16). The first gasket part (12), the second gasket part (14) and the interconnecting gasket part (16) are elongated and their longitudinal axes are arranged parallel to each other. The first gasket part (12) and the second gasket part (14) are impermeable for steam, vapour and/or humidity. The first gasket part (12) is made of an elastic material or a compound of elastic materials and is resistant against high temperatures. The second gasket part (14) is resistant against high temperatures and includes at least on electrically conductive material. The interconnecting gasket part (16) is resistant against high temperatures. The interconnecting gasket part (16) is permanently or removably connected to the first gasket part (12) at one side and to the second gasket part (14) at another side of said interconnecting gasket part (16). The gasket (12) is formed as an integral part. Further, the present invention relates to an appliance with microwave heating function for domestic or professional use, wherein the appliance includes at least one heat-charged cavity enclosed by at least one gap at least partially filled by the gasket (10).

The present invention relates to a gasket for a heat-charged cavity of an appliance with microwave heating function. Further, the present invention relates to an appliance with microwave heating function for domestic or professional use, wherein the appliance includes at least one heat-charged cavity enclosed by at least one gap.

In the near future, further innovative appliances with microwave heating function are expected. For example, dish-washers, washing machines, freezers with a fast defrosting system and laundry dryers may be heated up by microwaves. The removal of excess liquids, vapours and/or humidity from the heated cavity of the appliance may be improved by the microwave heating function.

Such an appliance requires a sealing of the gaps around the heated cavity. Usually the sealing is realized by one or more gaskets. Said gaskets must be heat resistant and impermeable for liquids, vapours, humidity and/or heat. However, within some types of gaps a microwave transparency is necessary, while other types of gaps should be sealed against microwaves.

It is an object of the present invention to provide an improved gasket for an appliance with microwave heating function, wherein the properties of the gasket are adapted to the requirements of said appliance by low complexity.

The object is achieved by the gasket according to claim 1.

According to the present invention the gasket is provided for a heat-charged cavity of an appliance with microwave heating function, wherein
the gasket comprises a first gasket part, a second gasket part and an interconnecting gasket part,
the first gasket part, the second gasket part and the interconnecting gasket part are elongated and their longitudinal axes are arranged parallel to each other,
the first gasket part and the second gasket part are impermeable for steam, vapour and/or humidity,
the first gasket part is made of an elastic material or a compound of elastic materials and is resistant against high temperatures,
the second gasket part is resistant against high temperatures and includes at least one electrically conductive material,
the interconnecting gasket part is resistant against high temperatures,
the interconnecting gasket part is permanently or removably connected to the first gasket part at one side and to the second gasket part at another side of said interconnecting gasket part, and
the gasket is formed as an integral part.

The first gasket part and the second gasket part of the gasket have different functions. The first gasket part as well as the second gasket part is heat resistant and impermeable for steam, vapour and/or humidity. However, the first gasket part is made of an elastic material or a compound of elastic materials, while the second gasket part includes at least one electrically conductive material. Thus, the first gasket part is transparent to microwaves, while the second gasket part cannot be penetrated by microwaves.

In particular, the interconnecting gasket part includes at least one flexible sheet.

Preferably, the at least one flexible sheet of the interconnecting gasket part encloses at least partially the first gasket part.

Further, the at least one flexible sheet of the interconnecting gasket part is partially received by the second gasket part.

According to the preferred embodiment of the present invention, the second gasket part includes a U-shaped cross-section. Thus, the second gasket part forms a U-shaped profile part.

In particular, the at least one flexible sheet of the interconnecting gasket part is partially received by the legs of the U-shaped cross-section of the second gasket part.

The first gasket part, the second gasket part and/or the interconnecting gasket part may be made of technical textiles, preferably on the basis of glass fibres.

For example, the second gasket part includes glass fibres coated by at least one electrically conductive material, preferably metallic material.

According to another example, the second gasket part includes glass fibres interwoven with fibres made of at least one electrically conductive material, preferably metallic material.

Alternatively or additionally, the second gasket part may include small metallic particles equally distributed within said second gasket part.

Furthermore, the second gasket part includes at least one metal grid.

The present invention relates further to an appliance with microwave heating function for domestic or professional use, wherein the appliance includes at least one heat-charged cavity enclosed by at least one gap, wherein the at least one gap is at least partially filled by a gasket mentioned above.

Preferably, the appliance comprises at least two adjacent gaps, wherein a first gap is at least partially filled by the first gasket part and a second gap is at least partially filled by the second gasket part.

In particular, the first gap is arranged between a door at one side and an inner chassis part and/or outer chassis part of the appliance at another side, wherein said first gap occurs in a closed state of the door. Thereby, the inner chassis part may be the cavity, while the outer chassis part may be a front frame.

In contrast, the second gap may be arranged between an inner chassis part and an outer chassis part of the appliance, in particular the second gap is arranged between the cavity and the front frame, wherein the second gap forms a thermal barrier.

For example, the cross-sections of the first gap and the second gap are arranged orthogonal to each other.

Alternatively or additionally, the cross-sections of the first gap and the second gap may be arranged serially to each other.

Novel and inventive features of the present invention are set forth in the appended claims.

The present invention will be described in further detail with reference to the drawing, in which

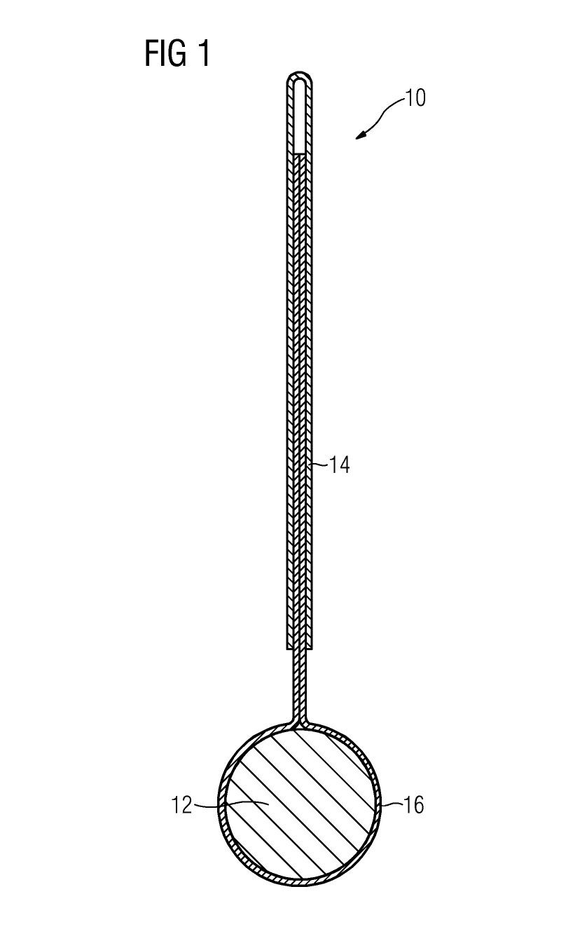

FIG. 1 illustrates a schematic cross-sectional view of as gasket according to a preferred embodiment of the present invention.

FIG. 1 illustrates a schematic cross-sectional view of as gasket 10 according to a preferred embodiment of the present invention. The gasket 10 is elongated, wherein the longitudinal axis of said gasket 10 extends perpendicular to the plane of the drawing in FIG. 1.

The gasket 10 comprises a first gasket part 12, a second gasket part 14 and an interconnecting gasket part 16. The first gasket part 12, the second gasket part 14 and the interconnecting gasket part 16 are also elongated. The longitudinal axes of the first gasket part 12, the second gasket part 14 and the interconnecting gasket part 16 extend in parallel to each other. The gasket 10 is composed by the first gasket part 12, the second gasket part 14 and the interconnecting gasket part 16 and forms an integral part.

In this example, the first gasket part 12 has a circular cross-section. The first gasket part 12 is resistant against high temperatures. Further, the first gasket part 12 is thermally insulating. Moreover, the first gasket part 12 is impermeable for vapour, steam and humidity. The first gasket part 12 is transparent to microwaves.

The interconnecting gasket part 16 connects the first gasket part 12 and the second gasket part 14. The interconnecting gasket part 16 is made of one or more flexible sheets. In this example, a central portion of the cross-section of the interconnecting gasket part 16 encloses the first gasket part 12, while both end portions of the cross-section of the interconnecting gasket part 16 are received by the second gasket part 14.

In this example, the second gasket part 14 has a U-shaped cross-section, wherein the end portions of the cross-section of the interconnecting gasket part 16 are received between the legs of said U-shaped cross-section. In other words, the second gasket part 14 forms a U-shaped profile part. In this example, the legs of the U-shaped profile part are relative long in view of the width of said U-shaped profile part. The second gasket part 14 is also resistant against high temperatures. Furthermore, the second gasket part 14 cannot be penetrated by microwaves. The second gasket part 14 is also thermally insulating and impermeable for vapour, steam and humidity.

The first gasket part 12 blocks heat and is impermeable for vapour, steam and humidity, but transparent to microwaves. Preferably, the first gasket part 12 is made of material including technical textiles. In particular, said technical textiles base on glass fibres. The first gasket part 12 is made of an elastic material or by an elastic compound of materials. A gap of variable size can be sealed by the first gasket part 12 made of elastic material. For example, said variable size of the gap may be caused by tolerances of production. The first gasket part 12 with the elastic material allows the required seal effect along the sealing line of the gasket 10.

The second gasket part 14 is made of at least one heat temperature resistant material. The second gasket part 14 blocks heat and is impermeable for vapour, steam and humidity. Additionally, the second gasket part 14 cannot be penetrated by microwaves. The second gasket part 14 or at least an outer layer of said second gasket part 14 includes metallic material or materials.

Preferably, the metallic material includes technical textiles. For example, said technical textiles base on metalized glass fibres. The technical textiles or the fibres may be coated by electrically conductive material. Further, the glass fibres may be connected with fibres of electrically conductive material, preferably metallic material. For example, the glass fibres may be interwoven with fibres of electrically conductive material, preferably metallic material. Alternatively or additionally, the second gasket part may include small metallic particles equally distributed within said second gasket part. Furthermore, the second gasket part may include at least one metal grid. The second gasket part 14 can be connected form-fit and/or force-fit to the surrounding receptacle area of the appliance.

The gasket 10 blocks humidity, vapour, liquids, steam and/or heat by the first gasket part 12 and the second gasket part 14. Additionally, the gasket 10 shows microwave blockage by the second gasket part 14.

In particular, the gasket 10 is provided for sealing of closed heat-charged cavities of appliance with microwave heating function. The gasket 10 may be used for all appliances for domestic and professional use with microwave heating function. Further, the gasket 10 is suitable for washing machines, laundry dryers and dish-washers, wherein at least one drying process of dishes, laundry and/or the cavity itself is improved by microwave heating. The gasket 10 is also suitable for appliances, wherein the process time is reduced by microwave heating. Moreover, the gasket 10 is suitable for appliances, wherein other functions of said appliances are improved by microwave heating. For example, the gasket 10 can be used for appliances, wherein sterilization is performed by microwave heating.

The gasket 10 may be provided for sealing two independent gaps. In particular, said gaps are adjacent to each other. The cross-section of the gaps may be arranged orthogonal or serial to each other. Further, the gasket 10 may be provided for sealing one single gap.

For example, the first gasket part 12 may be provided for a gap formed between a door at the one side and the cavity and/or a front frame on the other side. More general, the first gasket part 12 may be provided for a gap variable by the action of the user. Such a gap needs to be sealed against dirt, vapour, moist and/or steam. However, said gap must not form a microwave barrier. The microwave barrier in said gap would excessively heat up the first gasket part 12.

For example, the second gasket part 14 is provided for a gap formed between the cavity and the front frame of the appliance. More general, the second gasket part 14 is provided for a gap formed between an inner chassis part and an outer chassis part of the appliance. Such kind of gap is predetermined by the construction of the appliance, but does not depend on the action of the user. Usually, such a gap forms a thermal barrier. A microwave barrier is required in said gap.

Although an illustrative embodiment of the present invention has been described herein with reference to the accompanying drawing, it is to be understood that the present invention is not limited to that precise embodiment, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 gasket
12 first gasket part
14 second gasket part
16 interconnecting gasket part

1. A gasket for a heat-charged cavity of an appliance with microwave heating function, wherein
the gasket comprises a first gasket part, a second gasket part and an interconnecting gasket part,
the first gasket part, the second gasket part and the interconnecting gasket part are elongated and their longitudinal axes are arranged parallel to each other,
the first gasket part and the second gasket part are impermeable for steam, vapour and/or humidity,
the first gasket part is made of an elastic material or a compound of elastic materials and is resistant against high temperatures,
the second gasket part is resistant against high temperatures and includes at least one electrically conductive material,
the interconnecting gasket part is resistant against high temperatures, the interconnecting gasket part is permanently or removably connected to the first gasket part at one side and to the second gasket part at another side of said interconnecting gasket part, and
the gasket is formed as an integral part.

2. The gasket according to claim 1, characterized in that the interconnecting gasket part includes at least one flexible sheet.

3. The gasket according to claim 2, characterized in that the at least one flexible sheet of the interconnecting gasket part encloses at least partially the first gasket part and/or is partially received by the second gasket part.

4. The gasket according to claim 2, characterized in that the second gasket part includes a U-shaped cross-section, wherein the at least one flexible sheet of the interconnecting gasket part is partially received by the legs of the U-shaped cross-section of the second gasket part.

5. The gasket according to claim 1, characterized in that the first gasket part, the second gasket part and/or the interconnecting gasket part are made of technical textiles.

6. The gasket according to claim 1, characterized in that the second gasket part includes glass fibres coated by at least one electrically conductive material.

7. the gasket according to claim 1, characterized in that the second gasket part includes glass fibres interwoven with fibres made of at least one electrically conductive material.

8. The gasket according to claim 1, characterized in that the second gasket part includes small metallic particles equally distributed within said second gasket part.

9. The gasket according to claim 1, characterized in that the second gasket part includes at least one metal grid.

10. An appliance with microwave heating function for domestic or professional use, wherein the appliance includes at least one heat-charged cavity enclosed by at least one gap, characterized in that the at least one gap is at least partially filled by a gasket according to claim 1.

11. The appliance according to claim 10, characterized in that the appliance comprises at least two adjacent gaps, wherein a first gap is at least partially filled by the first gasket part and a second gap is at least partially filled by the second gasket part.

12. The appliance according to claim 11, characterized in that the first gap is arranged between a door at one side and the cavity and/or a front frame at another side, wherein said first gap occurs in a closed state of the door.

13. The appliance according to claim 11, characterized in that the second gap is arranged between an inner chassis part and an outer chassis part of the appliance.

14. The appliance according to claim 11, characterized in that the cross-sections of the first gap and the second gap are arranged orthogonal to each other.

15. The appliance according to claim 11, characterized in that the cross-sections of the first gap and the second gap are arranged serially to each other.

16. The gasket according to claim 5, said technical textiles comprising glass fibres.

17. The gasket according to claim 6, said at least one electrically conductive material comprising metallic material.

18. The gasket according to claim 7, said at least one electrically conductive material comprising metallic material.

19. The appliance according to claim 13, said second gap being arranged between the cavity and the front frame, wherein the second gap forms a thermal barrier.
